(19) United States
(12) Patent Application Publication
(10) Pub. No.: US 2026/0016641 A1
(43) Pub. Date: Jan. 15, 2026

(54) OPTICAL CONNECTION COMPONENT, METHOD OF MANUFACTURING DEVICE, AND DEVICE

(71) Applicant: SUMITOMO ELECTRIC INDUSTRIES, LTD., Osaka (JP)

(72) Inventors: Yasunori ASANO, Osaka (JP); Takeshi Inoue, Osaka (JP); Masaki Suzuki, Osaka (JP); Shun Endo, Osaka (JP)

(73) Assignee: SUMITOMO ELECTRIC INDUSTRIES, LTD., Osaka (JP)

(21) Appl. No.: 19/239,445

(22) Filed: Jun. 16, 2025

(30) Foreign Application Priority Data
Jul. 12, 2024 (JP) 2024-112298

(51) Int. Cl. G02B 6/36; G06F 1/16

(52) U.S. Cl. CPC G02B 6/3616; G06F 1/1683

(57) ABSTRACT

An optical connection component is disclosed. The optical connection component includes an optical fiber having a first end and a second end opposite to the first end, and a hinge component through which the optical fiber passes.

### CROSS-REFERENCE TO RELATED APPLICATION

This application claims priority based on Japanese Patent Application No. 2024-112298 filed on Jul. 12, 2024, and the entire contents of the Japanese patent application are incorporated herein by reference.

### TECHNICAL FIELD

The present disclosure relates to an optical connection component, a method of manufacturing a device, and a device.

### BACKGROUND

JP2011-119698A discloses an openable electronic device having a hinge component. In such an electronic device, electrical components mounted on two housings rotatably coupled by a hinge component are coupled by an electrical wiring passing through the hinge component. Another openable electronic device with a hinge component is disclosed in JPH06-131077A and JP2001-154760A.

### SUMMARY

An optical connection component according to an embodiment of the present disclosure includes an optical fiber having a first end and a second end opposite to the first end, and a hinge component through which the optical fiber passes.

### BRIEF DESCRIPTION OF THE DRAWINGS

FIG. 1 is a perspective view illustrating an optical connection component according to a first embodiment.

FIG. 2 is a schematic diagram illustrating a structure of the optical connection component shown in FIG. 1, particularly a structure of optical components at both ends.

FIG. 3A is a plan view illustrating a size relationship between a through hole of a hinge component and an optical component.

FIG. 3B is a plan view illustrating a size relationship between a through hole of a hinge component and an optical component of a modification.

FIG. 3C is a plan view for explaining a tapered shape provided in a through hole of a hinge component.

FIG. 4 is a perspective view illustrating an example of a case where the optical connection component shown in FIG. 1 is mounted on an information device.

FIG. 5 is a perspective view illustrating an optical connection component according to a second embodiment.

FIG. 6 is a perspective view illustrating an optical connection component according to a third embodiment.

FIG. 7 is a perspective view illustrating an optical connection component according to a fourth embodiment.

FIG. 8 is a view illustrating the optical connection component shown in FIG. 7 with an assisting member removed.

FIG. 9 is a schematic diagram illustrating an optical fiber in the assisting member of the optical connection component shown in FIG. 7.

FIG. 10A is a diagram illustrating a modification of the optical fiber routing in the optical connection component shown in FIG. 7.

FIG. 10B is a diagram illustrating another modification of the optical fiber routing in the optical connection component shown in FIG. 7, illustrating an example in which an excess portion is provided.

FIG. 11 is a schematic diagram illustrating an optical connection component according to a fifth embodiment.

### DETAILED DESCRIPTION

In an openable and closable electronic device including a hinge component, it is desired to increase a transmission capacity between electrical components attached to each of two housings rotatably connected by the hinge component. On the other hand, if the number of electric wires is increased in order to increase the transmission capacity, reducing the size or thickness of the electronic device is impeded. Thus, it is desired to reduce the size or thickness of an openable and closable device while increasing the transmission capacity.

An object of the present disclosure is to provide an optical connection component capable of reducing the size or thickness of an openable and closable device while increasing the transmission capacity.

First, the contents of embodiments of the present disclosure will be listed and explained.
(1) An optical connection component according to an embodiment of the present disclosure includes an optical fiber having a first end and a second end opposite to the first end, and a hinge component through which the optical fiber passes.

In the optical connection component of (1), an optical fiber is used. Thus, the transmission capacity can be greatly increased as compared with a case of electric wiring. Further, since the transmission capacity can be increased significantly, the number of required wirings can be reduced, and the size or thickness of the openable and closable device on which the optical connection component is mounted can be reduced.
(2) The optical connection component according to (1) may further include a first optical component optically connected to the first end of the optical fiber. In this case, since the optical component is attached to the optical fiber in advance, the optical connection component can be easily attached to the device.
(3) In the optical connection component according to (2), the first optical component may include a first lens module including at least one of a light receiving element and a light emitting element. In this case, since the light receiving/emitting element is attached to the optical fiber in advance, the optical connection component can be easily attached to the device.
(4) In the optical connection component according to (3), the first optical component may further include a first substrate on which the first lens module is mounted, and a first connector provided with the first substrate. In this case, the optical connection component can be easily attached to the device.
(5) The optical connection component according to (4) may further include a second optical component optically connected to the second end of the optical fiber. The second optical component may include a second lens module including at least one of a light receiving element and a light emitting element, a second substrate on which the second lens module is mounted, and a second connector provided with the second substrate. In this case, the optical connection component can be more easily attached to the device.
(6) In the optical connection component according to any one of (2) to (5), the hinge component may have a hole through which the optical fiber passes, and the first optical component may have a size with which the first optical component is not able to pass through the hole. In this case, the optical fiber is prevented from coming off the hinge component in the optical connection component. Thus, the optical connection component can be easily attached to the device.
(7) In the optical connection component according to any one of (1) to (6), the optical fiber may pass through the hinge component so as to intersect a hinge axis of the hinge component. In this case, the optical fiber can be easily wired in the device.
(8) In the optical connection component according to any one of (1) to (6), the optical fiber may pass through the hinge component so as to be parallel to a hinge axis of the hinge component. In this case, the degree of freedom of wiring of the optical fiber in the device can be increased.
(9) In the optical connection component according to any one of (1) to (8), an excess portion of the optical fiber may be provided at at least one of a position between the first end and the hinge component and a position inside the hinge component. Thus, even when an external force such as a tensile force is applied to the optical fiber, the optical fiber is prevented from being broken and is protected.
(10) In the optical connection component according to any one of (1) to (9), the hinge component may have a hole through which the optical fiber passes, and the hole may be provided with at least one tapered portion. Thus, even if the optical fiber is rubbed against the edge of the hole, the optical fiber is prevented from being broken and is protected.
(11) In the optical connection component according to any one of (1) to (10), the hinge component may have a hole through which the optical fiber passes, and a protection member configured to protect the optical fiber may be provided between the hole and the optical fiber. Thus, even when the optical fiber is rubbed against the hole, the optical fiber is prevented from being broken and is protected.
(12) In the optical connection component according to any one of (1) to (11), the hinge component may include a first member, and a second member rotatable about a hinge axis with respect to the first member. In this case, the hinge component functions reliably.
(13) In the optical connection component according to (12), the first member may have a first through hole through which the optical fiber passes, and the second member may have a second through hole through which the optical fiber passes. In this case, the optical fiber can be reliably passed through the hinge component.
(14) In the optical connection component according to (13), the first through hole and the second through hole may face each other or may be displaced from each other when the first member and the second member are closed. In this case, the number of options for the method of passing the optical fiber through the hinge can be increased.
(15) In the optical connection component according to any one of (12) to (14), at least one of the first member and the second member may have a third through hole along the hinge axis, and the optical fiber may pass through the third through hole. In this case, the number of options for the method of passing the optical fiber through the hinge can be increased.
(16) In the optical connection component according to any one of (1) to (15), the hinge component may include a hinge body including a first member and a second member, the first member and the second member being rotatable about a hinge axis with respect to each other, and a hinge assisting member attached to the hinge body, and the optical fiber may pass through the hinge assisting member. In this case, the optical fiber can be wired through the hinge component without impeding the function of the hinge body that performs the opening and closing operation.
(17) In the optical connection component according to any one of (1) to (16), the optical fiber may be a multimode optical fiber. In this case, the optical connection of the optical fiber can be made in a simple structure while obtaining the transmission capacity as the optical fiber.
(18) In the optical connection component according to any one of (1) to (17), the optical fiber may be slidable with respect to the hinge component. Thus, even when an external force such as a tensile force is applied to the optical fiber, the optical fiber is prevented from being broken and is protected.
(19) The optical connection component according to any one of (1) to (18) may further include an electric wire having a first end and a second end opposite to the first end, and the electric wire may pass through the hinge component. In this case, the optical wiring and the electric wiring can be used in combination.
(20) A method of manufacturing a device according to an embodiment includes preparing the optical connection component according to any one of (1) to (19); preparing a first device member and a second device member; attaching the hinge component of the optical connection component to at least one of the first device member and the second device member; and attaching a first part of the optical fiber of the optical connection component, the first part including the first end, to the first device member. In this case, a device which is reduced in size or thickness while increasing the transmission capacity can be easily manufactured.
(21) In the method of manufacturing a device according to (20), attaching of the first part of the optical fiber may be performed after attaching of the hinge component. In this case, the optical connection component can be easily attached to the device (a first device member). Further, the optical fiber can be prevented from being damaged.
(22) The method of manufacturing a device according to (21) may further include attaching a second part of the optical fiber of the optical connection component, the second part including the second end, to the second device member, and attaching of the second part of the optical fiber may be performed after attaching of the hinge component. Attaching of the second part of the optical fiber may be performed after attaching of the hinge component. In this case, the optical connection component can be easily attached to the device (a second device member). Further, the optical fiber can be prevented from being damaged.
(23) A device according to an embodiment includes the optical connection component according to any one of (1) to (19), a first device member, and a second device member. The first device member is attached to the second device member by the hinge component of the optical connection component so as to be rotatable with respect to the second device member. A first part of the optical fiber, the first part including the first end, is attached to the first device member, and a second part of the optical fiber, the second part including the second end, is attached to the second device member. Thus, the device is reduced in size or thickness while increasing the transmission capacity.

Specific examples of an optical connection component, a method of manufacturing a device, and a device according to embodiments of the present disclosure will be described below with reference to the drawings. In the following description, the same elements or elements having the same functions are denoted by the same reference numerals, and redundant description will be omitted. The present invention is not limited to these examples, but is defined by the scope of the claims, and is intended to include all modifications within the meaning and scope equivalent to the scope of the claims.

### First Embodiment

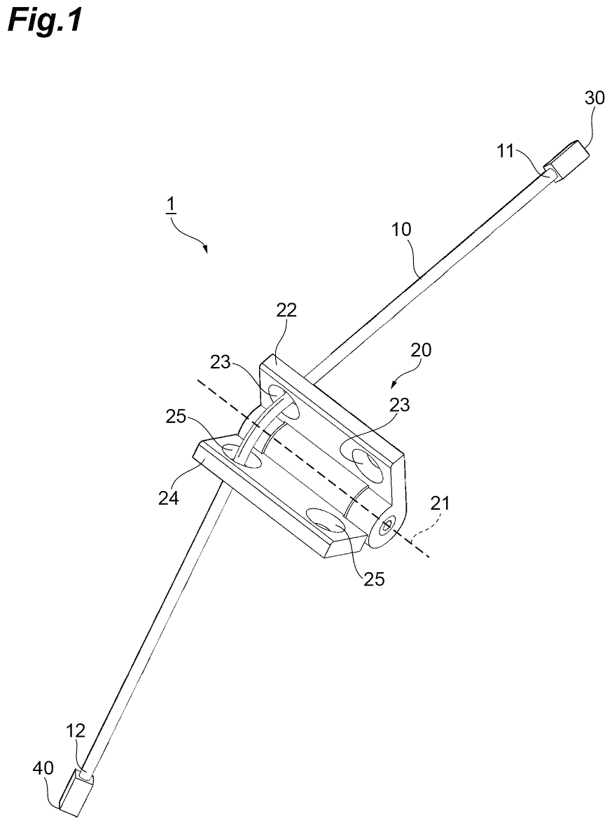

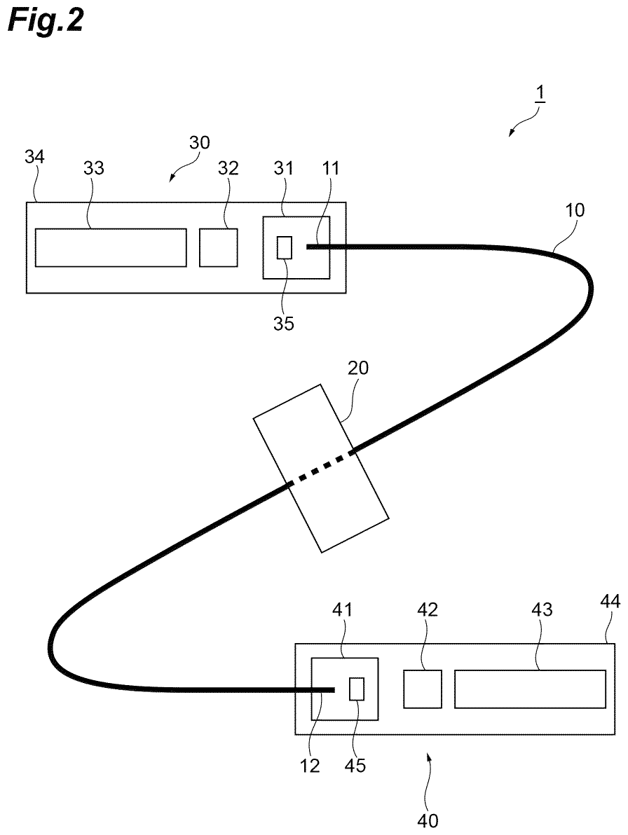

Referring to FIGS. 1 and 2, an optical connection component according to a first embodiment will be described. FIG. 1 is a perspective view illustrating an optical connection component according to a first embodiment. FIG. 2 is a schematic diagram for explaining a structure of the optical connection component shown in FIG. 1, particularly, a structure of optical components at both ends.

As shown in FIG. 1, an optical connection component 1 includes an optical fiber 10, a hinge component 20, a first optical component 30, and a second optical component 40. The optical fiber 10 includes a first end 11 and a second end 12 opposite to the first end 11. The optical fiber 10 is a member in which a glass fiber including a core and a cladding is covered with one or more resin layers. The optical fiber 10 is, for example, a multimode optical fiber. The multimode optical fiber has a large core diameter and is strong against bending and the like. However, the optical fiber 10 may be a single-mode optical fiber. The optical fiber 10 may be a plastic optical fiber (POF) or a plastic clad fiber (PCF), in addition to the glass fiber.

The hinge component 20 includes a hinge axis 21, a first member 22, and a second member 24. The second member 24 is attached to the first member 22 so as to be rotatable about the hinge axis 21 with respect to the first member 22. The first member 22 is, for example, a plate-like member made of metal, and is provided with at least one through hole 23 (first through hole). The through hole 23 penetrates the plate-like member. In the example shown in FIG. 1, for example, two through holes 23 are provided. The second member 24 is, for example, a plate-like member made of metal, and is provided with at least one through hole 25 (second through hole). The through hole 25 penetrates the plate-like member. In the example shown in FIG. 1, for example, two through holes 25 are provided.

The optical fiber 10 passes through the through hole 23 and the through hole 25 located on the same side. The through hole 23 and the through hole 25 through which the optical fiber 10 passes are arranged so as to face each other when the first member 22 and the second member 24 are closed.

As shown in FIG. 2, the first optical component 30 includes a first lens module 31, a control IC 32, a connector 33, and a substrate 34. The first lens module 31 includes at least one optical element 35 of a light receiving element or a light emitting element. The first end 11 of the optical fiber 10 is attached to the first lens module 31. The first lens module 31 has a lens member, and optically couples the first end 11 of the optical fiber 10 to the optical element 35 by the lens member. The optical element 35 may be mounted on the substrate 34 as an example. In this case, the first lens module 31 converts light extending in a direction parallel to the substrate 34 into light extending in a direction orthogonal to the substrate 34.

The control IC 32 controls processing such as photoelectric conversion in the optical element 35 of the first optical component 30. When the optical element 35 is a light receiving element, the control IC 32 outputs the photoelectrically converted electric signal to the connector 33. When the optical element 35 is a light emitting element, the control IC 32 sends the electrical signal input from the connector 33 to the optical element 35, causes the electrical signal to be photoelectrically converted, and causes the converted optical signal to be incident on the optical fiber 10.

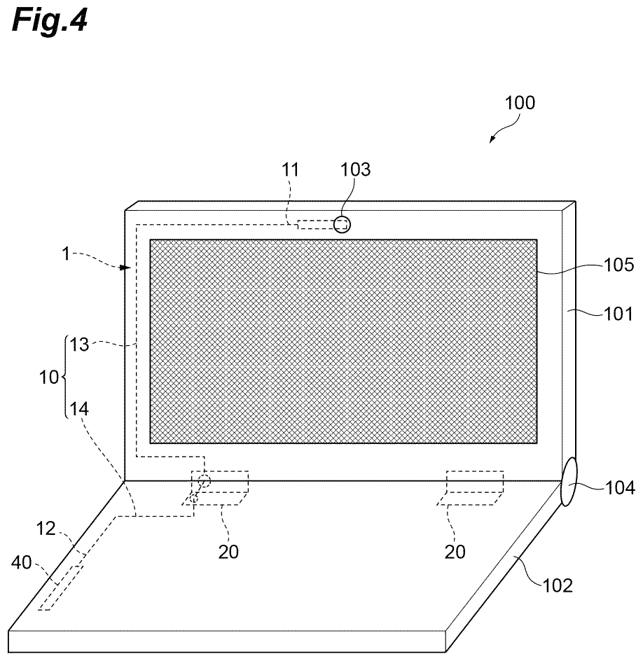

The connector 33 is a member for directly or indirectly connecting an electrical component (for example, a camera module 103) incorporated in an electronic device 100 (see FIG. 4) to which the optical connection component 1 is attached. Various connectors can be used as the connector 33.

The substrate 34 is, for example, a rectangular substrate, and the first lens module 31, the control IC 32, and the connector 33 are mounted thereon. Various substrates can be used as the substrate 34.

The second optical component 40 includes a second lens module 41, a control IC 42, a connector 43, and a substrate 44. The second lens module 41 includes at least one optical element 45 of a light receiving element or a light emitting element. The second end 12 of the optical fiber 10 is attached to the second lens module 41. The second lens module 41 has a lens member, and optically couples the second end 12 of the optical fiber 10 to the optical element 45 by the lens member. The optical element 45 may be mounted on the substrate 44 as an example. In this case, the second lens module 41 converts light extending in a direction parallel to the substrate 44 into light extending in a direction orthogonal to the substrate 44. The second optical component 40 may have the same structure as the first optical component 30, and in this case, the second lens module 41, the control IC 42, the connector 43, and the substrate 44 have structures corresponding to the first lens module 31, the control IC 32, the connector 33, and the substrate 34, respectively.

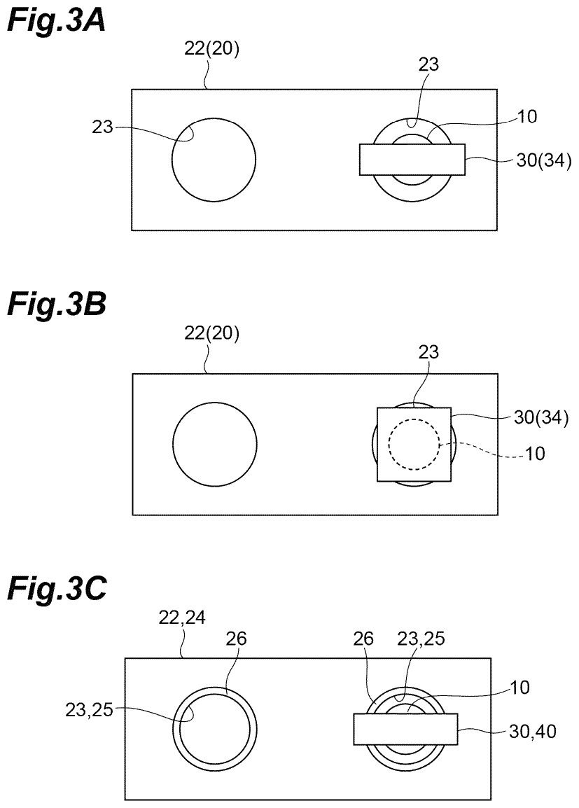

Here, the size relationship between the first optical component 30 and the through hole 23 of the first member 22 of the hinge component 20 will be described with reference to FIG. 3A. As shown in FIG. 3A, in the optical connection component 1, the first optical component 30 (substrate 34) has a portion which is larger than the through hole 23 in the lateral direction. As shown in FIG. 3B, the first optical component 30 may be formed to be larger than the through hole 23 in both the vertical and horizontal directions. Although not shown in the drawings, the size relationship between the second optical component 40 and the through hole 25 of the second member 24 is the same as that shown in FIG. 3A or FIG. 3B. Due to such a relationship, the optical fiber 10 is prevented from coming off the hinge component 20.

The optical connection component 1 can be manufactured by attaching the first optical component 30 and the second optical component 40 to both ends (the first end 11 and the second end 12) of the optical fiber 10 after the optical fiber 10 is passed through holes 23 and 25 of the hinge component 20. Alternatively, the optical connection component 1 may be manufactured by attaching the first optical component 30 or the second optical component 40 to one end of the optical fiber 10, then passing the optical fiber 10 through the hinge component 20, and then attaching the remaining optical component to the optical fiber 10.

As shown in FIG. 3C, a tapered portion 26 may be provided at the edge of the through holes 23 and 25 of the hinge component 20 through which the optical fiber 10 passes. The tapered portion 26 is formed so as to be widened from the inside of the through holes 23 and 25 toward the outside thereof. The tapered portion 26 may be provided on both sides of the through holes 23 and 25, or may be provided on the outside or the inside thereof. The tapered portion 26 may have an R shape as well as a shape gradually expanding outward.

Next, a method of mounting the optical connection component 1 on the electronic device 100 such as a PC and a form of mounting the optical connection component 1 will be described with reference to FIG. 4. The electronic device 100 includes a first device member 101, a second device member 102, the camera module 103, and a hinge mechanism 104. When the electronic device 100 is a laptop PC, the first device member 101 is provided with, for example, a display 105, and the second device member 102 is provided with a keyboard (not shown).

In order to incorporate the optical connection component 1 when manufacturing the electronic device 100, first, the optical connection component 1 in which the optical fiber 10 is passed through the hinge component 20 is prepared. In addition, the first device member 101 and the second device member 102 of the electronic device 100 are prepared. The first device member 101 and the second device member 102 include a housing and various electronic devices (the camera module 103, the display 105, and the like) installed in the housing. When these preparations are completed, the hinge component 20 of the optical connection component 1 is attached to the first device member 101 and the second device member 102. The hinge component 20 is attached to each member so as to be positioned in the hinge mechanism 104.

When attaching of the hinge component 20 is completed, a first part 13 including the first end 11 of the optical fiber 10 of the optical connection component 1 is attached to the first device member 101. Similarly, a second part 14 including the second end 12 of the optical fiber 10 of the optical connection component 1 is attached to the second device member 102. This attaching is performed by attaching each portion of the optical fiber 10 to each member with, for example, a tape or the like. As described above, in the manufacturing method using the optical connection component 1 according to the embodiment, the first part 13 and the second part 14 of the optical fiber 10 are attached to the first device member 101 and the second device member 102, respectively, after the hinge component 20 is attached to the first device member 101 and the second device member 102.

When the first part 13 and the second part 14 of the optical fiber 10 are attached to the housing, the first optical component 30 of the optical connection component 1 is electrically connected to the electric component such as the camera module 103. Similarly, the second optical component 40 is electrically connected to a control circuit (for example, a CPU) or the like built in the second device member 102. In this way, an electronic device in which the optical connection component 1 is incorporated is manufactured.

As described above, the optical connection component 1 according to the first embodiment uses the optical fiber 10. Thus, the transmission capacity can be increased significantly in the incorporated electronic device 100 compared to the case of electrical wiring. For example, signals from an electrical component having a large transmission capacity, such as the camera module 103, can be easily transmitted by the optical connection component 1. In addition, since the transmission capacity can be significantly increased by using the optical connection component 1, the number of wirings required in the electronic device 100 can be reduced, and the size or thickness of the openable and closable electronic device 100 in which the optical connection component 1 is mounted can be reduced.

The optical connection component 1 according to the embodiment includes the first optical component 30 optically connected to the first end 11 of the optical fiber 10 and the second optical component 40 optically connected to the second end 12. In this way, since the optical component for connection is attached to the optical fiber 10 in advance, the optical connection component 1 can be easily attached to the electronic device 100.

In the optical connection component 1 according to the embodiment, the hinge component 20 includes the through holes 23 and 25 through which the optical fiber 10 passes, and the first optical component 30 and the second optical component 40 have a size that the first optical component 30 and the second optical component 40 does not pass through the corresponding through holes 23 and 25. Thus, the optical fiber 10 is prevented from coming off the hinge component 20 in the optical connection component 1. Thus, the optical connection component 1 can be easily attached to the electronic device 100.

In the optical connection component 1 according to the embodiment, the optical fiber 10 is passed through the hinge component 20 so as to be orthogonal to (intersect) the hinge axis 21 of the hinge component 20. In this case, the optical fiber 10 can be easily wired in the electronic device 100.

In the optical connection component 1 according to the embodiment, the tapered portion 26 may be provided in the through holes 23 and 25 of the hinge component 20. Thus, even when the optical fiber 10 is rubbed against the edge of the through holes 23 and 25, the optical fiber 10 is prevented from being broken and is protected.

In the optical connection component 1 according to the embodiment, the optical fiber 10 is slidable with respect to the hinge component 20. Thus, even when an external force such as a tensile force is applied to the optical fiber 10, the optical fiber 10 is prevented from being broken and is protected.

### Second Embodiment

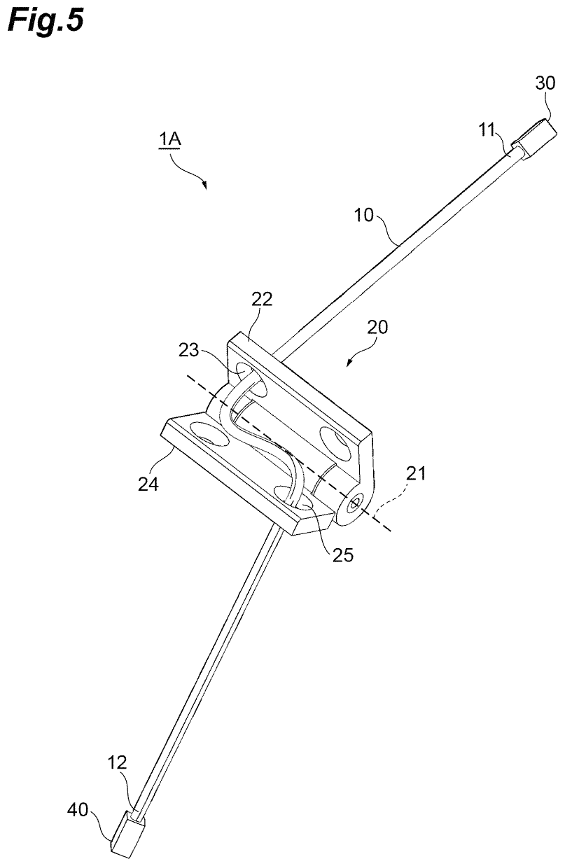

Next, an optical connection component 1A according to the second embodiment will be described with reference to FIG. 5. Hereinafter, the description of the same points as those of the first embodiment may be omitted. As shown in FIG. 5, the optical connection component 1A includes the optical fiber 10, the hinge component 20, the first optical component 30, and the second optical component 40, as in the first embodiment. In the optical connection component 1A, the position of the through hole 25 through which the optical fiber 10 passes is different, and the through hole 25 is not opposite to the through hole 23 through which the optical fiber 10 passes but is shifted from the through hole 23. Other structures are the same as those of the optical connection component 1, and the incorporation into the electronic device 100 is also the same.

In the optical connection component 1A according to the second embodiment, similarly to the optical connection component 1 according to the first embodiment, the transmission capacity can be significantly increased in the electronic device 100 in which the optical connection component 1A is incorporated. In addition, the number of wirings required in the electronic device 100 can be reduced, and the size or thickness of the openable and closable electronic device 100 in which the optical connection component 1A is mounted can be reduced.

### Third Embodiment

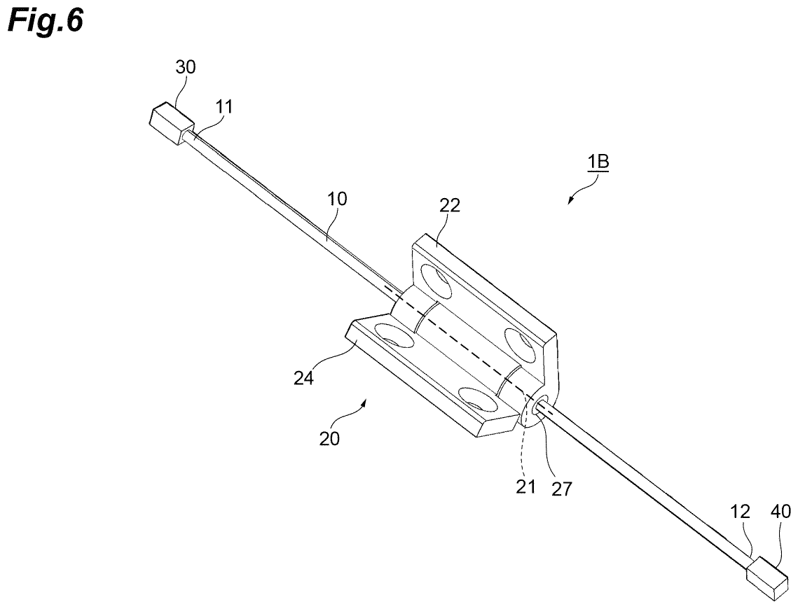

Next, an optical connection component 1B according to a third embodiment will be described with reference to FIG. 6. Hereinafter, the description of the same points as those of the first embodiment may be omitted. As shown in FIG. 6, the optical connection component 1B includes the optical fiber 10, the hinge component 20, the first optical component 30, and the second optical component 40, as in the first embodiment. In the optical connection component 1B, the position and the extending direction of the through hole 27 (third through hole) through which the optical fiber 10 passes are different. The through hole 27 extends along the hinge axis 21 of the hinge component 20, and the optical fiber 10 is passed through the through hole 27 so as to be parallel to the hinge axis 21. Other structures are the same as those of the optical connection component 1, and the incorporation into the electronic device 100 is also the same.

In the optical connection component 1B according to the third embodiment, similarly to the optical connection component 1 according to the first embodiment, the transmission capacity can be significantly increased in the electronic device 100 in which the optical connection component 1B is incorporated. In addition, the number of wirings required in the electronic device 100 can be reduced, and the size or thickness of the openable and closable electronic device 100 in which the optical connection component 1B is mounted can be reduced. In the optical connection component 1B according to the embodiment, the optical fiber 10 is passed through the hinge component 20 so as to be parallel to the hinge axis 21 of the hinge component 20. Thus, the degree of freedom of wiring of the optical fiber 10 in the device can be increased.

The optical connection component according to the present disclosure may combine two or three of the first embodiment, the second embodiment and the third embodiment of the optical fiber 10.

### Fourth Embodiment

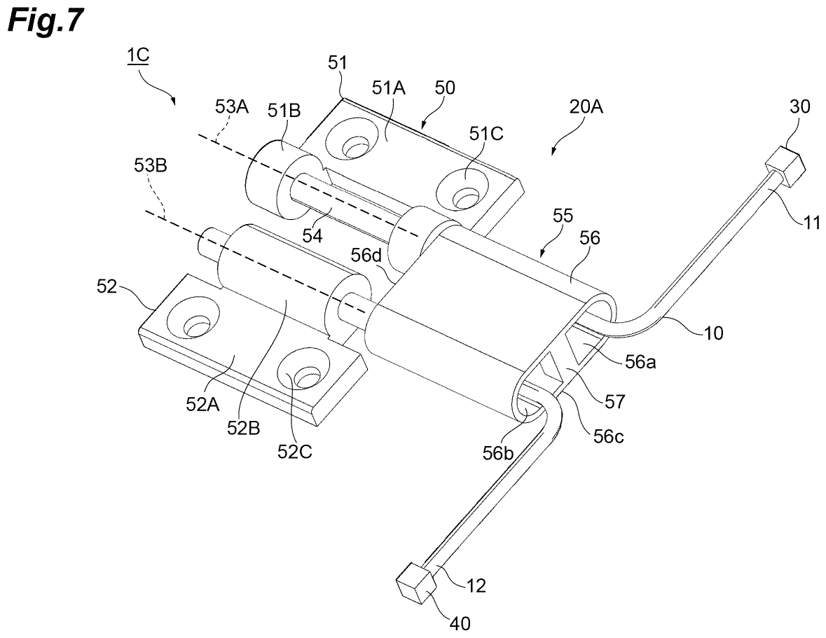

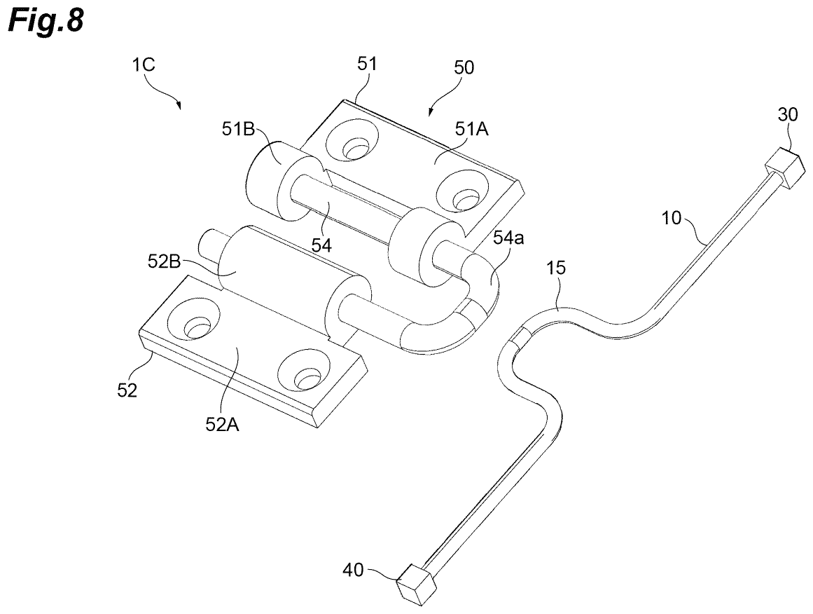

Next, an optical connection component 1C according to a fourth embodiment will be described with reference to FIGS. 7, 8, and 9. Hereinafter, the description of the same points as those of the first embodiment and the like may be omitted. As shown in FIGS. 7 and 8, the optical connection component 1C includes the optical fiber 10, a hinge component 20A, the first optical component 30, and the second optical component 40. In the optical connection component 1C, the structure of the hinge component 20A is different from that of the first embodiment and the like. The structure of the optical fiber 10, the first optical component 30, and the second optical component 40 are the same as that of the optical connection component 1, and the incorporation thereof into the electronic device 100 is also the same. Since the structure of the hinge component 20A is different, the way of passing the optical fiber 10 is different from that of the first embodiment.

The hinge component 20A includes a hinge body 50 and a hinge assisting member 55.

The hinge body 50 includes a first member 51 and a second member 52. The second member 52 is attached to the first member 51 via a U-shaped shaft member 54 so as to be rotatable about two hinge axes 53A and 53B with respect to the first member 51. The first member 51 includes a plate portion 51A which is a plate-like member, for example, made of metal, and a cylinder portion 51B which is made of metal, is connected to the plate portion 51A, and into which the shaft member 54 is inserted. The plate portion 51A is provided with screw holes 51C for fixing the hinge component 20A (hinge body 50) to the first device member 101 (see FIG. 4) of the electronic device 100. The second member 52 includes a plate portion 52A which is a plate-like member, for example, made of metal, and a cylinder portion 52B which is made of metal, is connected to the plate portion 52A, and into which the shaft member 54 is inserted. The plate portion 52A is provided with screw holes 52C for fixing the hinge component 20A (hinge body 50) to the second device member 102 (see FIG. 4) of the electronic device 100.

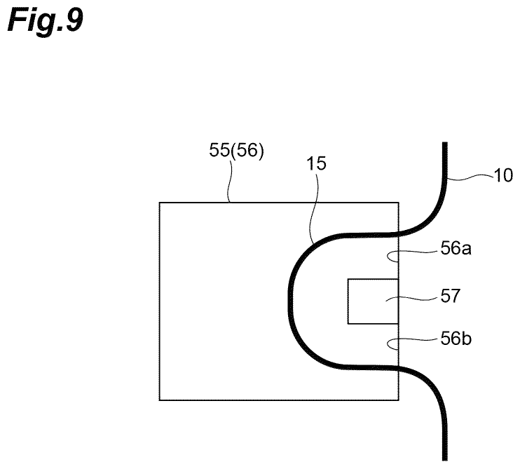

The hinge assisting member 55 is a member for passing the optical fiber 10 therethrough, and includes a housing 56 and a fastener 57. As shown in FIG. 9, the optical fiber 10 is passed through holes 56a and 56b of the housing 56, and a curved portion 15 of the optical fiber 10 is formed in the housing 56. The holes 56a and 56b are formed on the same side of the housing 56. The fastener 57 is a member for loosely fastening the optical fiber 10 so that the optical fiber 10 does not come off the inside of the housing 56. The fastener 57 may be integrated with or separated from the housing 56.

The housing 56 has a first end 56c into which the optical fiber 10 is inserted and a second end 56d opposite to the first end 56c. In the hinge component 20A, a protruding portion 54a of the shaft member 54 of the hinge body 50 is inserted into the second end 56d of the housing 56, and thus the hinge body 50 and the hinge assisting member 55 are combined to function as one hinge component. The optical fiber 10 may be formed so as not to come off the hinge component 20A, or may be formed so as to be slidable, as in the first embodiment and the like.

As described above, the optical connection component 1C according to the fourth embodiment uses the optical fiber 10 as in the first embodiment and the like. Thus, the transmission capacity can be increased significantly in the incorporated electronic device compared to the case of electrical wiring. Further, since the transmission capacity can be significantly increased by using the optical connection component 1C, the number of wirings required in the electronic device can be reduced, and the size or thickness of the openable and closable electronic device on which the optical connection component 1C is mounted can be reduced.

In the optical connection component 1C according to the embodiment, the hinge component 20A includes the hinge body 50 including the first member 51 and the second member 52 which are rotatable with respect to each other about the hinge axes 53A and 53B, and the hinge assisting member 55 attached to the hinge body 50. The optical fiber 10 is passed through the hinge assisting member 55. Thus, the optical fiber 10 can be wired through the hinge component 20A without impeding the function of the hinge body 50 that performs the opening and closing operation. The optical connection component 1C can also achieve other effects similar to those of the first to third embodiments.

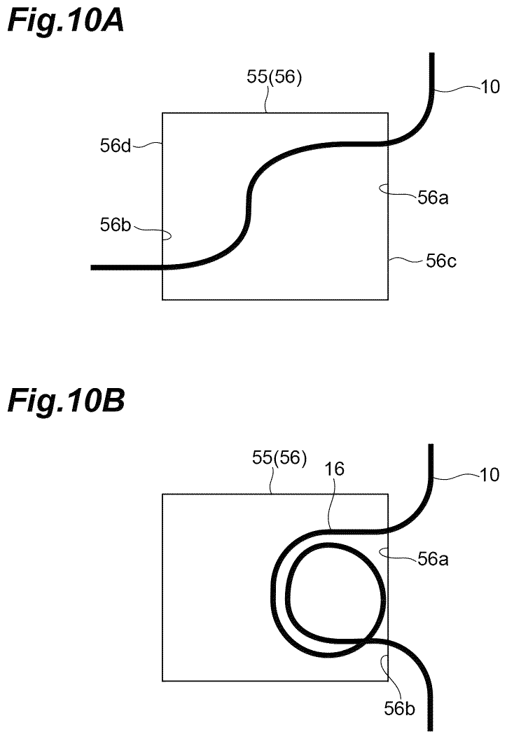

In the optical connection component 1C according to the embodiment, as shown in FIG. 10A, the optical fiber 10 may be drawn out from the hole 56b on the opposite side of the inserted hole 56a in the housing 56 of the hinge assisting member 55 to be inserted. By such a way of passing, the degree of freedom of wiring using the optical connection component 1C can be improved.

In the optical connection component 1C according to the embodiment, as shown in FIG. 10B, the optical fiber 10 may be wound in the housing 56 of the inserted hinge assisting member 55. Thus, the excess portion 16 of the optical fiber 10 can be provided in the hinge component 20A (the hinge assisting member 55). Such an excess portion 16 may be provided not only in the hinge component 20A but also between the first end 11 to which the first optical component 30 is attached and the hinge component 20A and between the second end 12 to which the second optical component 40 is attached and the hinge component 20A. Even when an external force such as a tensile force is applied to the optical fiber 10, the excess portion 16 prevents the optical fiber 10 from being broken, and the optical fiber 10 is protected.

The optical connection component, the method of manufacturing an electronic device using the optical connection component, and the electronic device according to the present disclosure have been described in detail above, but the present disclosure is not limited to the above embodiments, and can be applied to various embodiments and modifications. For example, in any of the optical connection components 1, 1A, 1B, and 1C described above, a protection member for protecting the optical fiber 10 may be provided between a hole (through hole) through which the optical fiber 10 passes and the optical fiber 10. As such a protection member, for example, a member having elasticity such as sponge or rubber can be used. Thus, even when the optical fiber 10 is rubbed by the edge of the hole, the optical fiber 10 is prevented from being broken and is protected.

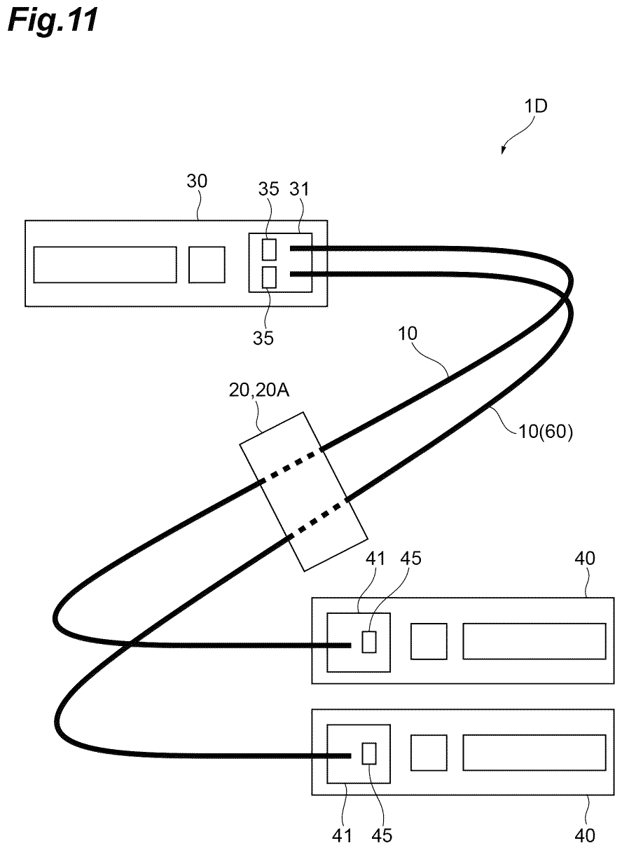

In the above-described embodiment, the optical connection components 1, 1A, 1B, and 1C each include one optical fiber 10. However, the present invention is not limited to this. That is, as shown in FIG. 11, an optical connection component 1D may include two or more optical fibers 10, and the two or more optical fibers may be passed through one hinge component 20, 20A. In addition, the optical connection component 1D may further include an electric wire 60 including a first end and a second end on the opposite side of the first end in addition to the optical fiber 10. The electric wire 60 passes through the hinge components 20 and 20A, similarly to the optical fiber 10. In this case, the optical fiber 10 can be used to transmit data such as images and sounds, and the electric wire 60 can be used to supply power. The first optical component 30 and the second optical component 40 attached to both ends of the optical fiber 10 may be optical connectors. In this case, after the assembly, the optical module can be connected to another optical component via the optical connector.

What is claimed is:

1. An optical connection component comprising:
an optical fiber having a first end and a second end opposite to the first end; and
a hinge component through which the optical fiber passes.

2. The optical connection component according to claim 1, further comprising:
a first optical component optically connected to the first end of the optical fiber.

3. The optical connection component according to claim 2,
wherein the first optical component includes a first lens module including at least one of a light receiving element and a light emitting element.

4. The optical connection component according to claim 3,
wherein the first optical component further includes
a first substrate on which the first lens module is mounted, and
a first connector provided with the first substrate.

5. The optical connection component according to claim 4, further comprising:
a second optical component optically connected to the second end of the optical fiber,
wherein the second optical component includes
a second lens module including at least one of a light receiving element and a light emitting element,
a second substrate on which the second lens module is mounted, and
a second connector provided with the second substrate.

6. The optical connection component according to claim 2,
wherein the hinge component has a hole through which the optical fiber passes, and
wherein the first optical component has a size with which the first optical component is not able to pass through the hole.

7. The optical connection component according to claim 1,
wherein the optical fiber passes through the hinge component so as to intersect a hinge axis of the hinge component.

8. The optical connection component according to claim 1,
wherein the optical fiber passes through the hinge component so as to be parallel to a hinge axis of the hinge component.

9. The optical connection component according to claim 1,
wherein an excess portion of the optical fiber is provided at at least one of a position between the first end and the hinge component and a position inside the hinge component.

10. The optical connection component according to claim 1,
wherein the hinge component has a hole through which the optical fiber passes, and
wherein the hole is provided with at least one tapered portion.

11. The optical connection component according to claim 1,
wherein the hinge component has a hole through which the optical fiber passes, and
wherein a protection member configured to protect the optical fiber is provided between the hole and the optical fiber.

12. The optical connection component according to claim 1,
wherein the hinge component includes
a first member, and
a second member rotatable about a hinge axis with respect to the first member.

13. The optical connection component according to claim 12,
wherein the first member has a first through hole through which the optical fiber passes, and
wherein the second member has a second through hole through which the optical fiber passes.

14. The optical connection component according to claim 13,
wherein the first through hole and the second through hole face each other or are displaced from each other when the first member and the second member are closed.

15. The optical connection component according to claim 12,
wherein at least one of the first member and the second member has a third through hole along the hinge axis, and
wherein the optical fiber passes through the third through hole.

16. The optical connection component according to claim 1,
wherein the hinge component includes
a hinge body including a first member and a second member, the first member and the second member being rotatable about a hinge axis with respect to each other, and
a hinge assisting member attached to the hinge body, and
wherein the optical fiber passes through the hinge assisting member.

17. The optical connection component according to claim 1,
wherein the optical fiber is slidable with respect to the hinge component.

18. The optical connection component according to claim 1, further comprising:
an electric wire having a first end and a second end opposite to the first end,
wherein the electric wire passes through the hinge component.

19. A method of manufacturing a device, the method comprising:
preparing the optical connection component according to claim 1;
preparing a first device member and a second device member;
attaching the hinge component of the optical connection component to at least one of the first device member and the second device member; and
attaching a first part of the optical fiber of the optical connection component, the first part including the first end, to the first device member.

20. A device comprising:
the optical connection component according to claim 1;
a first device member; and
a second device member,
wherein the first device member is attached to the second device member by the hinge component of the optical connection component so as to be rotatable with respect to the second device member, and
wherein a first part of the optical fiber, the first part including the first end, is attached to the first device member, and a second part of the optical fiber, the second part including the second end, is attached to the second device member.
